(19) United States
(12) Patent Application Publication
(10) Pub. No.: US 2025/0344886 A1
(43) Pub. Date: Nov. 13, 2025

(54) INTERCHANGEABLE SILVERWARE SYSTEM

(71) Applicant: Krew Consulting LLC, Centennial, CO (US)

(72) Inventors: Kennedy Nedved, Centennial, CO (US); Wade Nedved, Centennial, CO (US); Jason Nedved, Britt, IA (US)

(21) Appl. No.: 19/204,767

(22) Filed: May 12, 2025

Related U.S. Application Data
(60) Provisional application No. 63/645,469, filed on May 10, 2024.
(60) Provisional application No. 63/761,250, filed on Feb. 21, 2025.

(51) Int. Cl. A47G 21/06; B25G 1/10

(52) U.S. Cl. CPC A47G 21/06; B25G 1/10

(57) ABSTRACT

The embodiments here relate to various utensils and utensil attachments including components that can be interchanged between standard and specific utensils and can be adapted to provide sensory feedback to users.

### CROSS-REFERENCE TO RELATED APPLICATIONS

This application claims the benefit under 35 U.S.C. § 119(e) to U.S. Provisional Application 63/645,469, filed on May 10, 2024, and entitled “Interchangeable Silverware System,” and U.S. Provisional Application 63/761,250, filed on Feb. 21, 2025, and entitled “Interchangeable Silverware System,” which are hereby incorporated herein by reference in their entireties.

### FIELD

The various embodiments herein relate to interchangeable utensil systems.

### BACKGROUND

Persons with sensory disorders may require sensory feedback when completing a task. For example, some people may employ fidget tools to obtain such sensory feedback. Certain tasks and tools may not provide sensory feedback, however. Such tasks may include, for example, eating and/or preparing food.

While eating, hands are typically engaged either in holding the food and/or a utensil used to hold the food. This can restrict the ability of a user's hands to engage with sensory feedback tools. Utensils typically do not provide sensory feedback, nor are utensils typically individually adapted to sensory feedback needs.

### BRIEF SUMMARY

Discussed herein are embodiments related to various utensils and utensil attachments including components that can be interchanged between standard and specific utensils and can be adapted to provide sensory feedback to users.

In Example 1, a utensil comprises a utensil head, a handle with a lock, a neck connecting the utensil head to the handle, and a first removable handle sleeve. The removable handle sleeve includes an open end configured to be disposed adjacent the neck, a closed end opposite the open end, and a sleeve wall extending from the open end to the closed end. The sleeve wall has an inner surface and a first tactile outer surface and forming a cavity configured to receive the handle and the lock. The handle is insertable into the handle sleeve, and wherein the first tactile outer surface comprises a manipulable unit.

Example 2 relates to the utensil according to Example 1, wherein the handle comprises a handle width, the lock comprises a lock width, and the lock width is wider than the handle width, and the inner surface comprises a wall width such that the cavity is configured to house the handle.

Example 3 relates to the utensil according to Example 2, wherein the lock comprises at least one bulb and the inner surface comprises a plurality of bulb shapes configured to receive a bulb.

Example 4 relates to the utensil according to Example 1, wherein the first tactile outer surface comprises at least one texture.

Example 5 relates to the utensil according to Example 1, wherein the utensil head is selected from a group consisting of a fork, a knife, a spork, and a spoon.

Example 6 relates to the utensil according to Example 1, further comprising a flange disposed at the open end of the handle sleeve, the flange being configured to prevent food from contacting the handle sleeve.

Example 7 relates to the utensil according to Example 1, further comprising a second removable handle sleeve, the second removable handle sleeve comprising a second open end configured to be disposed adjacent the neck, a second closed end opposite the second open end, and a second sleeve wall extending from the second open end to the second closed end. The second sleeve wall comprises a second inner surface and a second tactile outer surface that is different than the first tactile outer surface and forming a second cavity configured to receive the handle and the lock.

Example 8 relates to the utensil according to Example 1, wherein the second tactile outer surface comprises at least one manipulable unit and/or texture.

In Example 9, a utensil sleeve comprises an open end, a closed end opposite the open end, and a wall extending from the open end to the closed end. The wall comprises an inner surface and a tactile outer surface and forming a cavity, A utensil handle is disposable into the utensil sleeve, and wherein the tactile outer surface comprises at least one manipulable unit.

Example 10 relates to the utensil sleeve according to Example 9, further comprising a flange disposed at the open end of the utensil sleeve, the flange being configured to prevent food from contacting the handle sleeve.

Example 11 relates to the utensil sleeve according to Example 9, wherein the manipulable unit comprises at least one of a button, a switch, a wheel, a stick, a first texture, and a second texture.

Example 12 relates to the utensil sleeve according to Example 9, wherein the utensil or handle sleeve comprises a collar and a handle portion.

Example 13 relates to the utensil sleeve according to Example 12, wherein the collar comprises a snap having a snap hook.

Example 14 relates to the utensil sleeve according to Example 12, wherein the handle portion comprises a slot and a hook receiver.

Example 15 relates to the utensil sleeve according to Example 12, wherein the handle portion comprises a snap having a snap hook.

Example 16 relates to the utensil sleeve according to Example 12, wherein the collar comprises a slot and a hook receiver.

In Example 17, a utensil sleeve comprises a handle assembly having a first handle half, a second handle half, and a hinge, at least one manipulable device on an exterior portion of the handle assembly, and a locking mechanism configured to selectively hold the first handle half and the second handle half in a closed position.

Example 18 relates to the utensil sleeve according to Example 17, wherein the locking mechanism is a clasp.

Example 19 relates to the utensil sleeve according to Example 18, wherein the clasp comprises a receiver and a retention arm. The retention arm is configured to be manipulated such that a retention flange on the retention arm is moved into a retention space defined by a reciprocal flange on the receiver.

Example 20 relates to the utensil sleeve according to Example 17, further comprising an impressionable material disposed within each of the first and second handle halves.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present invention and therefore do not limit the scope of invention. The drawings are not necessarily to scale, though embodiments may include the scale illustrated, and are intended for use in conjunction with the explanations in the following detailed description wherein like reference characters denote like elements. Examples of the present invention will hereinafter be described in conjunction with the appended drawings.

FIG. 1A is a perspective view of an interchangeable utensil system, in accordance with one or more examples of this disclosure.

FIG. 1B is a front view of an interchangeable utensil system, in accordance with one or more examples of this disclosure.

FIG. 2A is a perspective view of an interchangeable utensil system, in accordance with one or more examples of this disclosure.

FIG. 2B is a front view of an interchangeable utensil system, in accordance with one or more examples of this disclosure.

FIG. 3 is a front view of a handle of a utensil of an interchangeable utensil system, in accordance with one or more examples of this disclosure.

FIG. 4A is a bottom view of a sleeve of an interchangeable utensil system, in accordance with one or more examples of this disclosure.

FIG. 4B is a cross-sectional view of a sleeve of an interchangeable utensil system at line A-A of FIG. 4A, in accordance with one or more examples of this disclosure.

FIG. 5A is a front view of a sleeve of an interchangeable utensil system, in accordance with one or more examples of this disclosure.

FIG. 5B is a front view of a sleeve of an interchangeable utensil system, in accordance with one or more examples of this disclosure.

FIG. 5C is a front view of a sleeve of an interchangeable utensil system, in accordance with one or more examples of this disclosure.

FIG. 5D is a front view of a sleeve of an interchangeable utensil system, in accordance with one or more examples of this disclosure.

FIG. 6 is a perspective view of a flange of an interchangeable utensil system, in accordance with one or more examples of this disclosure.

FIG. 7 is a perspective view of a sleeve of an interchangeable utensil system, in accordance with one or more examples of this disclosure.

FIG. 8 is a cutaway view in the interior of an interchangeable utensil system, in accordance with one or more examples of this disclosure.

FIG. 9 is a cross sectional view of the collar of an interchangeable utensil system, in accordance with one or more examples of this disclosure.

FIG. 10 is a perspective view of a sleeve of an interchangeable utensil system in a closed position, in accordance with one or more examples of this disclosure.

FIG. 11 is a perspective view of a sleeve of an interchangeable utensil system in an open position with a utensil handle therewithin, in accordance with one or more examples of this disclosure.

FIG. 12 is a perspective view of a sleeve of an interchangeable utensil system in an open position, in accordance with one or more examples of this disclosure.

FIG. 13 is a schematic drawing of a clasp of an interchangeable utensil system, in accordance with one or more examples of this disclosure.

### DETAILED DESCRIPTION

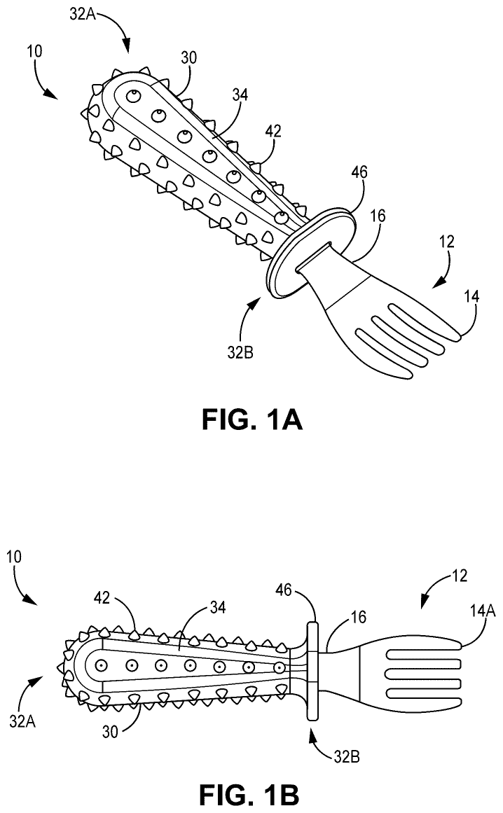

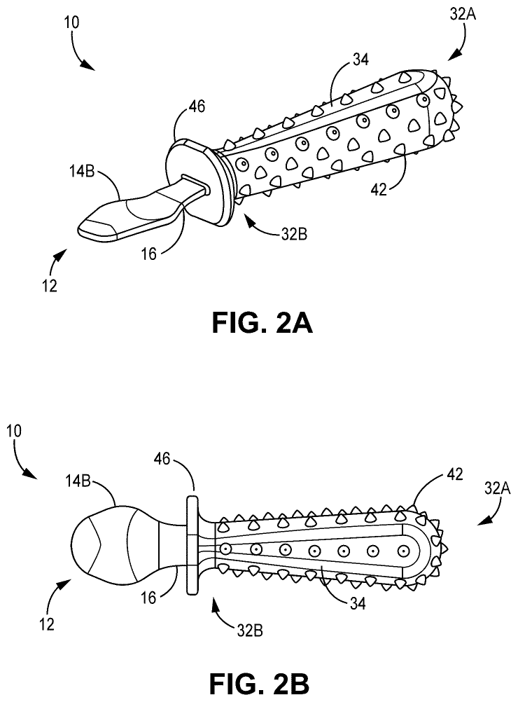

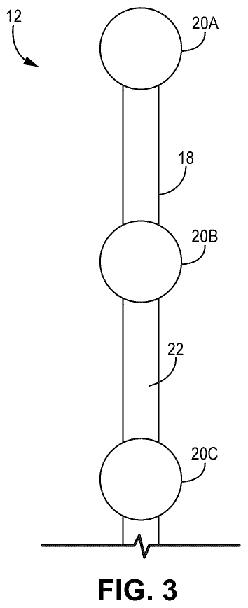

The embodiments herein relate to interchangeable utensil systems. The utensil system 10 may include a utensil 12 and a handle sleeve 30, as shown in FIG. 1A-2B (referred to herein as “FIG. 1” and “FIG. 2,” respectively). The handle sleeve 30 may be placed over a handle (see reference numeral 18 as shown in FIG. 3) of the utensil 12 such that the handle is securely yet removably disposed within the handle sleeve 30. In some embodiments, the handle sleeve 30 may include a flange 46 disposed on an end of the handle sleeve 30 proximal to the utensil head 14.

The utensil 12 may include a neck 16 connecting the utensil head 14 to the utensil handle 18. The utensil head 14 may be a fork 14A, as shown in FIG. 1. In other embodiments, such as that of FIG. 2, the utensil head 14 may be a spoon 14B. However, these embodiments are by no means limiting; the utensil head 14 may be any known utensil, including sporks, chopsticks, or any other utensils.

The utensil 12 may also include a handle 18. FIG. 3 shows a handle 18 of a utensil 12 configured for use with a utensil system 10. The handle 18 may include a stem 22. The stem 22 may be generally any length that would allow the handle 18 to be grasped and/or manipulated by a user either by itself or in combination with a handle sleeve 30. In some embodiments, the handle 18 and stem 22 are standard sizes for normal use. In other embodiments, the utensil 12 may be sized and arranged to fit specialty utensils such as toddler utensils or oversized utensils.

The handle 18 may include a variety of features used to position the handle 18 in a handle sleeve 30 of the utensil system 10. For example, in some embodiments, the handle 18 may include a locking mechanism 20. A locking mechanism in this case means a mechanism to hold the handle sleeve 30 in place on the utensil securely during normal use (e.g., when a user is using the utensil to eat). The locking mechanism 20 may have a width. The width of the locking mechanism 20 may be larger than the width of and extend outwardly from the stem 22. In some embodiments, the locking mechanism 20 may be one or more bulb shaped structures 20A-20C disposed on the stem 22 of the handle 18. The bulb shaped structure may be a width greater than the width of the handle stem 22. However, this is by no means limiting. In other embodiments, the locking mechanism 20 may be any shape configured to affix or attach the handle to a handle sleeve (discussed in further detail below).

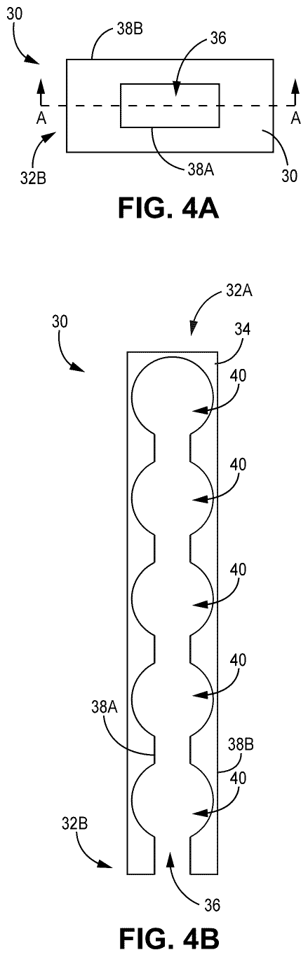

FIG. 4A shows an exemplary schematic bottom view of a handle sleeve 30. The handle sleeve 30 has an open end 32B and a closed end 32A, and a wall 34 extending from the open end 32B to the closed end 32A. The wall 34 forms a cavity 36. The handle 18 of the utensil 12 may be disposed within the cavity 36. In some embodiments, the cavity 36 may be generally the same shape as the handle 18 of the utensil 12. The handle sleeve 30 may be made of any material that provides suitable handling for the utensil, fits over the utensil handle 12, and has a generally pleasing exterior aesthetic. In some embodiments, the handle sleeve 30 may be made of pliable silicone. Some other examples of the handle sleeve 30 are made of a dishwasher-safe material.

FIG. 4B shows an exemplary schematic cross-sectional view of the interior of the handle sleeve 30 along line A-A of FIG. 4A. As discussed above, the cavity 36 is formed by an interior portion of the sleeve wall 34. The inner surface 38A of the cavity 36 defines the shape of the cavity 36. The shape of the cavity 36 may vary; the shape of the cavity 36 may be any shape configured to securely receive a utensil handle 18. For example, in some embodiments, the width of the cavity 36 may vary in a corresponding fashion such that the handle locking mechanism 20A-20C may be correspond to and be disposed within internal bulbs 40 of the cavity 36.

For example, the cavity 36 may include internal bulbs 40 that may be configured to hold at least one bulb 20 of the utensil handle 18 (e.g., that of FIG. 3). The bulb(s) 20A-20C of the utensil handle 18 may pass through a narrow portion of the cavity 36 until it enters into the internal bulb 40 of the cavity 36. The width of the bulb 20 may be larger than the width of a narrow portion of the cavity 36. Thus, when the bulb 20 passes through the narrow channel of the cavity 36, the handle 18 cannot be easily removed from the handle sleeve 30. The bulb-cavity interaction is one example of a locking mechanism; other locking mechanisms may be used to removably attach the handle 18 to the handle sleeve 30.

Conversely, the handle 18 may be removed from the handle sleeve 30. For example, a user may wish to remove the handle 18 from the handle sleeve 30 in order to wash the utensil system. To remove the handle 18 from the handle sleeve 30, a user may disengage the locking mechanism. This may include, for example, using enough force to pull the handle 18 and corresponding bulbs 20 out of the pliable handle sleeve 30 and corresponding internal bulbs 40. In other embodiments, disengaging the locking mechanism may require manipulation of a lock release button (not pictured) disposed on the handle sleeve 30.

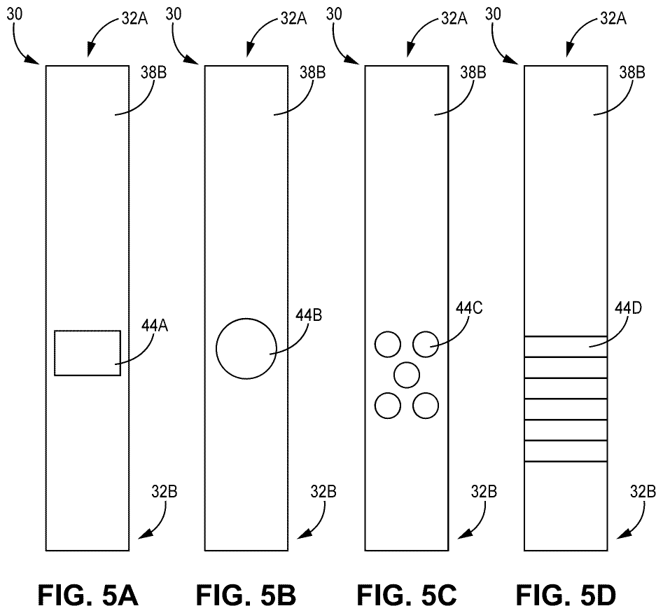

The handle sleeve may include manipulable features with which a user can interact. FIG. 5A-5D (collectively referred to herein as “FIG. 5”) shows variations in manipulable unit(s) 44 of the tactile outer surface 38B of the handle sleeve 30. The manipulable unit(s) 44 may be any structure or component that may be manipulated by a user. In some embodiments, such as that of FIG. 5A, the manipulable unit(s) 44 may be, for example, at least one of an analog stick, a button, a switch, a gear, or a roller ball. Some embodiments may include multiple analog sticks, buttons, switches, gears, or roller balls, or any combination thereof. The manipulable units may be any shape or configuration.

In other embodiments, the manipulable unit(s) 44 may be a repeated shape or pattern 42. For example, the manipulable unit 44 may be a repeated raised structure or component 42 disposed at various locations throughout the handle 18. In some embodiments, such as that of FIG. 1, the manipulable unit 44 may be disposed in a pattern along the handle 18. The pattern 42 may cover a portion of the handle 18. In other embodiments, the pattern 42 may cover the entirety of the handle 18.

The manipulable unit(s) 42, 44 may be located at a variety of locations on the handle 18. As discussed above, in some embodiments, the manipulable unit(s) 42, 44 may be disposed at any location on the handle 18. In other embodiments, the manipulable unit(s) 42, 44 may be disposed at a location on the handle 18 such that it is at or adjacent to the placement of a user's hand when a user is holding and/or using the utensil system 10. The manipulable unit(s) 42, 44 may be adjacent a user's fingers and/or a user's palm. Such manipulable units 42, 44 may provide sensory feedback to a user while eating by giving the user an object to manipulate, allowing them to occupy their hands while eating. In some cases, such sensory feedback can reduce restlessness in the user.

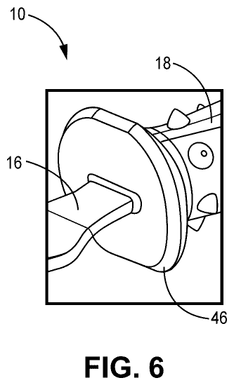

The handle 18 may include additional features. As shown in FIG. 6, the handle 18 may include a flange 46 disposed adjacent the open end 32B of the handle sleeve 30. The flange 46 may protrude from the perimeter of the handle wall 34 and may be generally perpendicular to the wall 34 and/or the neck 16 of the utensil 12.

In use, the flange 46 may act as a barrier between food and the handle sleeve 30. For example, the flange 46 may prevent the movement of food from coming into contact with the hand of a user (not pictured) and/or a handle sleeve 30, which may prevent a user or the system 10 from becoming dirty during use.

The system may include multiple handles 18 configured for use with one or more utensils 12. For example, different handle sleeves 30 may be used with different types of utensils 12. For example, the system 10 may include a second handle sleeve 18. The second handle sleeve 18 may include a second open end 32B and a second closed end 32A, which may be configured for use with the same utensil 12 as the first handle sleeve 30. Similar to the first handle sleeve 30, the second handle sleeve 30 may include a second inner wall 38A and a second outer wall 38B. The second inner wall 38A may be similar to the first inner wall 38A. The second outer wall 38B, however, may be different from the first outer wall 38B. That is, the second handle sleeve 30 may include at least one different manipulable unit(s) 42, 44 than the manipulable unit(s) 42, 44 of the first handle sleeve 30.

In systems including multiple utensils 12, each handle 18 may be configured for interchangeable use with other utensils 12. In such embodiments, a user may choose which handle cover or sleeve 30 the user will use with the utensil 12 from handle sleeves 30 including different embodiments of the tactile outer surface 38B. This may allow a user to use the system 10 while eating different meals, as different types of food may require different utensils 12.

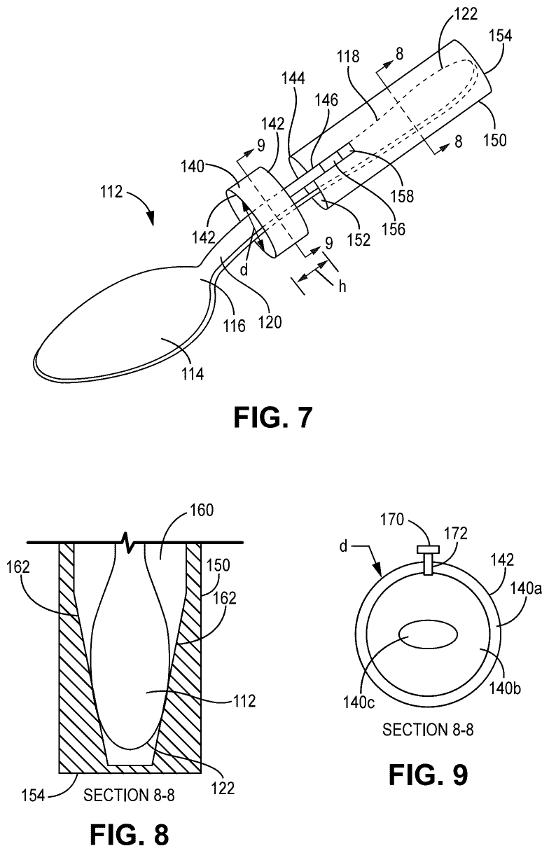

In some embodiments such as shown in FIG. 7, a handle assembly 130 may include a collar 140 and a handle portion 150 (also referred to herein as an interchangeable handle 150). The collar 140 may be attached and secured to a distal part 120 of the utensil handle 118, while the handle portion 150 of the handle assembly 130 may be removable attached to the collar 140 for quick and simple attachment and removal.

In some embodiments, the collar 140 may be any size, shape, and configuration and is configured to securely attach to the distal end 120 of the utensil handle 118 such that the handle portion 150 of the handle assembly 130 may removably attach thereto. The collar 140 may securely attach to the utensil 112 via a set screw, a clamp, or any other method known in the art. In some embodiments, the collar 140 may be cylindrical in shape with a height h that is shorter than a diameter d of the collar 140. The collar may include a snap 144 that extends from the perimeter 142 of the collar 140 toward the proximal end 122 of the utensil handle. The snap 144 may include a snap hook 146. The snap hook 146 may be any size, shape, and configuration to removably attach a handle portion 150 of the handle assembly 130 such that a user may easily and quickly remove and/or interchange the handle portion 150 of the handle assembly 130 by hand and without the use of tools.

In some embodiments, the handle portion 150 of the handle assembly 130 may be any size, shape, and configuration to fit over the handle 118 of a utensil 112 and removably attach to the collar 140 of the handle assembly 130. The handle portion 150 may be generally cylindrical in shape (e.g., as shown in FIG. 7 simplified for ease of showing the attachment methods) or may have any other shape with the manipulable units 44A-44D as described in detail above. The handle portion may include an open end 152 and a closed end 154 that are similar to the open and closed ends 32A, 32B as described above.

In some embodiments, the open end 152 of the handle portion 150 may abut the collar 140. The handle portion 150 may include a slot 156 and a hook receiving portion 158 (also referred to herein as the hook receiver 158) adjacent the open end 152 of the handle portion 150. The slot and hook receiver 156, 158 may be any size, shape, and configuration and be configured to removable couple to the snap 144 (also referred to herein as a snap body 144) and snap hook 146 of the collar 140.

In use, in some embodiments after the collar 140 is secured to the utensil handle 118 the open end 152 of the handle portion 150 may be urged over the proximal end 122 of the utensil handle 118. The handle portion is urged distally until the slot 156 contacts the snap 144 of the collar. The snap hook 146 slides along the slot 156 and is displaced upwardly, creating a slight bend in the snap 144. Once the snap hook 146 reaches the hook receiver 158 the snap hook 146 snaps downwardly and is held in place by the snap body 144.

When a user desires to remove the handle portion 150 from the utensil 112, the user lifts the snap hook 146 out of the hook receiver 158 and slides the handle proximally off the utensil handle 118. While the handle assembly 130 has been described as the snap 144 attached to the collar 140 and the slot 156 and hook receiver 158 as being disposed on the handle portion 150, it should be known that the various elements may be rearranged such that the snap 144 is disposed on the handle portion 150 and the slot 156 and hook receiver 158 may be disposed on the collar 140 without deviating from the scope of the disclosure.

In some embodiments such as shown in FIG. 8, the handle portion 150 includes an interior 160 having interior walls 162. The interior walls may be any size, shape, and configuration such that the utensil handle 118 is held securely (i.e., without any play between the utensil handle 118 and the handle portion 150 of the handle assembly). AS shown in FIG. 8, the interior walls 162 may be angled inwardly toward the proximal end of the handle portion 150 such that the handle assembly 130 may be used with a wide variety of shapes and designs of utensils 112. In some embodiments, the interior walls may be flexible such that wider or narrower handles 118 may be accommodated.

In some embodiments such as that shown in FIG. 9, the collar 140 may include an outer shell 140a. The outer shell may be any size shape and configuration to provide a stable platform for holding the utensil and providing the snap 146 as described above. As shown in FIG. 9, the outer shell has an outer perimeter 142 that is circular, but it should be known that the outer perimeter may be any shape such as an oval, square, triangle, pentagon, hexagon, or any other shape. The outer shell 140a may be any material that is stable enough to provide the stable platform for the snap, while providing enough flexibility for the snap to move over the hook receiver 158 and snap back into place. This material may be any thermoplastic such as nylon or polypropylene, glass-filled or not glass-filled, metal, or any other material known in the art.

In such embodiments, the collar 140 may include a flexible interior portion or diaphragm 140b. The diaphragm 140b may be any size, shape, and configuration to provide clearance to the proximal end 122 of the handle of the utensil 112 while simultaneously providing friction to hold securely the collar 140 to the utensil 112. The diaphragm 140b may include a clearance hole 140c to allow the proximal end 122 of the utensil 112 therethrough to locate the collar 140 onto the utensil 112 at the desired location.

In some embodiments, the collar 140 may include a set screw 170 that is inserted through a threaded hole 172 within the outer shell 140a of the collar 140. The set screw may provide a pushing force onto the diaphragm 140b of the collar 140 and against the handle 118 to increase the frictional force against the sliding of the collar 140 along the handle 118 of the utensil 112. By tightening the set screw 170 against the diaphragm 140b, the diaphragm 140b is squeezed, urging the material of the diaphragm 140b against the handle 118 and increasing the frictional force resisting sliding movement of the collar 140 with respect to the handle 118 of the utensil 112.

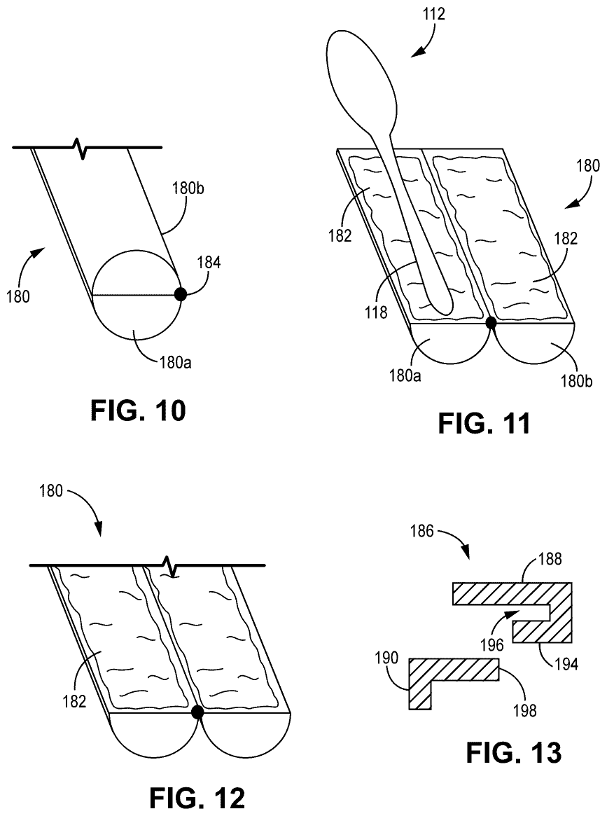

In still other embodiments, as shown in FIGS. 10-13 a handle assembly 180 may include two handle halves 180a, 180b. The handle halves 180a, 180b may be any size, shape, and configuration in order to provide an easy and method of attaching to a utensil 112. In such embodiments, the handle assembly 180 may be configured to attach to any known utensil 112 regardless of size, shape, or design.

As shown in FIGS. 10-12, each handle half 180a, 180b may be shaped in the form of a long cylinder cut in half along its axis. The handle halves 180a, 180b may be connected by a hinge 184. In some embodiments, the hinge 184 may be a single hinge that extends the length of the handle halves 180. In other embodiments, the hinge 184 may be a hinge located on either end of the handle halves 180, or may be a series of hinges 184 conveniently located along the length of the handle halves 180.

In some embodiments, the handle halves 180a, 180b may each comprise an outer shell that provides a stable base for the manipulable units (not explicitly shown in FIGS. 10-13) to be attached thereto. The outer shell of the handle halves additionally provides protection for and holds securely within an impressionable material 182. The impressionable material may be a gel-type of material held within a malleable outer casing (such as a thin plastic sack or the like) such that the utensil handle 118 may be placed therewithin and held securely by the clamping and frictional force of the impressionable material from either of the handle halves 180a, 180b, while simultaneously preventing the impressionable material from leaving residue on the utensil 112.

In certain of such embodiments, the handle halves 180a, 180b may rotate together about the hinge 184 and connect on an opposite of each of the handle halves 180a, 180b such that the handle assembly is generally cylindrical in shape around the utensil handle 118. As best shown in FIG. 13, the handle halves 180a, 180b may be held in place by a clasp 186. The clasp 186 may be located on the handle assembly 180 at the connection of the handle halves 180a, 180b opposite the hinge 184, or on an end of the handle assembly 180.

In some embodiments, the clasp 186 may comprise a receiver 188 and a retention arm 190. In some embodiments, the receiver 188 may include reciprocal arm 194 that defines a retention space 196. In some embodiments, the retention arm 190 may include a retention flange 198 extending outwardly from the retention arm. In some embodiments, the retention arm 190 is configured to rotate, slide, or otherwise move such that the retention flange 198 is moved into the retention space 196 and held in place by interference with the reciprocal arm 194. In other embodiments, the receiver is configured to rotate, slide, or otherwise move such that the retention flange 198 is moved into the retention space 196 and held in place by interference with the reciprocal arm 194. In still other embodiments, the handle halves are held in place by snaps, clips, or any other selectively lockable elements known in the art.

It should be known that in other embodiments, other devices may be utilized to provide the squeezing force of the diaphragm 140b to hold the collar 140 securely onto the utensil 112. In still other embodiments, the set screw 170 and the diaphragm 140b may be utilized within the end 152 of the handle portion 150, such that no collar is necessary to provide the securing force for the handle assembly 130.

While the various systems described above are separate implementations, any of the individual components, mechanisms, or devices, and related features and functionality, within the various system embodiments described in detail above may be incorporated into any of the other system embodiments herein.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The term “about” also encompasses these variations. The term “about” may include any variation of 5% or 10%, or any amount—including any integer—between 0% and 10%. Further, whether or not modified by the term “about,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A utensil, comprising:
(a) a utensil head;
(b) a handle comprising a lock;
(c) a neck connecting the utensil head to the handle;
(d) a first removable handle sleeve comprising:
(i) an open end configured to be disposed adjacent the neck;
(ii) a closed end opposite the open end; and
(iii) a sleeve wall extending from the open end to the closed end, the sleeve wall comprising an inner surface and a first tactile outer surface and forming a cavity configured to receive the handle and the lock,
wherein the handle is insertable into the handle sleeve, and wherein the first tactile outer surface comprises a manipulable unit.

2. The utensil of claim 1, wherein:
(a) the handle comprises a handle width, the lock comprises a lock width, and the lock width is wider than the handle width, and
(b) the inner surface comprises a wall width such that the cavity is configured to house the handle.

3. The utensil of claim 2, wherein the lock comprises at least one bulb and the inner surface comprises a plurality of bulb shapes configured to receive a bulb.

4. The utensil of claim 1, wherein the first tactile outer surface comprises at least one texture.

5. The utensil of claim 1, wherein the utensil head is selected from a group consisting of a fork, a knife, a spork, and a spoon.

6. The utensil of claim 1, further comprising a flange disposed at the open end of the handle sleeve, the flange being configured to prevent food from contacting the handle sleeve.

7. The utensil of claim 1, further comprising a second removable handle sleeve, the second removable handle sleeve comprising:
(a) a second open end configured to be disposed adjacent the neck;
(b) a second closed end opposite the second open end; and
(c) a second sleeve wall extending from the second open end to the second closed end, the second sleeve wall comprising a second inner surface and a second tactile outer surface that is different than the first tactile outer surface and forming a second cavity configured to receive the handle and the lock.

8. The utensil of claim 7, wherein the second tactile outer surface comprises at least one manipulable unit and/or texture.

9. A utensil sleeve, comprising:
(a) an open end;
(b) a closed end opposite the open end; and
(c) a wall extending from the open end to the closed end, the wall comprising an inner surface and a tactile outer surface and forming a cavity,
wherein a utensil handle is disposable into the utensil sleeve, and wherein the tactile outer surface comprises at least one manipulable unit.

10. The utensil sleeve of claim 9, further comprising a flange disposed at the open end of the utensil sleeve, the flange being configured to prevent food from contacting the handle sleeve.

11. The utensil sleeve of claim 9, wherein the manipulable unit comprises at least one of a button, a switch, a wheel, a stick, a first texture, and a second texture.

12. The utensil sleeve of claim 9, wherein the utensil or handle sleeve comprises a collar and a handle portion.

13. The utensil sleeve of claim 12, wherein the collar comprises a snap having a snap hook.

14. The utensil sleeve of claim 12, wherein the handle portion comprises a slot and a hook receiver.

15. The utensil sleeve of claim 12, wherein the handle portion comprises a snap having a snap hook.

16. The utensil sleeve of claim 12, wherein the collar comprises a slot and a hook receiver.

17. A utensil sleeve comprising:
(a) a handle assembly comprising:
(i) a first handle half;
(ii) a second handle half;
(ii) a hinge;
(b) at least one manipulable device on an exterior portion of the handle assembly; and
(c) a locking mechanism configured to selectively hold the first handle half and the second handle half in a closed position.

18. The utensil sleeve of claim 17, wherein the locking mechanism is a clasp.

19. The utensil sleeve of claim 18, wherein the clasp comprises:
(a) a receiver; and
(b) a retention arm;
wherein the retention arm is configured to be manipulated such that a retention flange on the retention arm is moved into a retention space defined by a reciprocal flange on the receiver.

20. The utensil sleeve of claim 17, further comprising an impressionable material disposed within each of the first and second handle halves.
